(19) United States
(12) Patent Application Publication
(10) Pub. No.: US 2014/0023886 A1
(43) Pub. Date: Jan. 23, 2014

(54) COMBINED MAGNETOHYDRODYNAMIC AND ELECTROCHEMICAL METHOD AND FACILITY FOR NAMELY ELECTRIC POWER GENERATION

(71) Applicants: Michal Mastena, Bratislava (SK); Pavol Perovi, Malacky (SK)

(72) Inventors: Michal Mastena, Bratislava (SK); Pavol Perovi, Malacky (SK)

(21) Appl. No.: 14/008,274

(22) PCT Filed: Apr. 20, 2012
(86) PCT No.: PCT/SK2012/050007

§ 371 Date: Sep. 27, 2013

(30) Foreign Application Priority Data
Apr. 21, 2011 (SK) PP 5022-2011

(51) Int. Cl. H01M 8/06; H01M 16/00; H02K 44/08

(52) U.S. Cl. CPC H01M 8/0656; H02K 44/08; H01M 16/003; H02N 11/008
USPC 429/9; 310/11; 429/411; 74/DIG. 9

(57) ABSTRACT

A combined magnetohydrodynamic and electrochemical method for namely electric power generation through a hydrogen-oxygen fusion in a hydrogen fuel cell uses an electrolytic process of decomposing water to hydrogen and oxygen in a spiral magnetic electrolyser under the surface of a water environment, where the dynamization of the water environment in the water supply system of the spiral magnetic electrolyser is induced by negative pressure resulting from water being decomposed at the outlet of the spiral magnetic electrolyser. A combined magnetohydrodynamic and electrochemical facility for namely electric power generation comprising a hydrogen fuel cell including at least one spiral magnetic electrolyser (1), with its inlet (2) submerged under the surface of a water environment (3). Connected to the outlet (4) of such positioned spiral magnetic electrolyser (1) is a gas separator (5) separating produced hydrogen from oxygen and at least one hydrogen fuel cell (6) with an outlet for water (7).

### FIELD OF THE INVENTION

The present invention relates to a combined magnetohydrodynamic and electrochemical method and corresponding facility for namely electric power generation. The aim of the present invention is to create an autonomous renewable energy source with positive energy balance, capable of delivering constant power without the need to create backup power capacity. The invention falls within the field of energy and water management.

### STATE OF THE ART

Known in the prior art is electric power generation based on hydrogen-oxygen fusion in a hydrogen fuel cell producing electric power, water and heat. Also known are various types of water electrolyses and electrolysers, such as PEM (Polymer Electrolyte Membrane) consisting of a membrane separating two metal electrodes. The membrane is made of a permeable polymer dissociating upon contact with water and becoming permeable for positive ions. The electrodes are made of platinum acting also as a water decomposition catalyst. Water is fed to the anode, where water molecules surrender their electrons and dissociate to oxygen O₂, positive hydrogen ions 4H⁺ and four free electrons. Produced oxygen together with unreacted water is collected in the anode flow channel. Free electrons are carried away by an applied external unidirectional electric field, i.e. the positive pole of a voltage source connected to the anode. Produced hydrogen ions H⁺ are transported through the membrane in the electric field to the cathode where they receive electrons providing a source of voltage and are reduced to hydrogen gas that is then drained away.

Another type of an electrolytic cell is described in U.S. Pat. No. 4,105,528. It is the SME (Spiral Magnetic Electrolyser) type, in which the cathode and anode are arranged in spirals not touching each other. This technology represents a low efficiency solution because based on the prior knowledge the device configured according to the patent requires more electric power to create a sufficiently strong magnetic field than conventionally used electrolysis facilities.

With respect to the claimed method of connecting the facilities into an integrated autonomous electric power generating system it is necessary to point out the processing of heat as an additional output from the PEM fuel cell, where for example the heat produced by the PEM hydrogen fuel cell can be turned into electric power as described in US Patent Application 20060216559 by using the coolant liquid circulating between two separate PEM hydrogen fuel cells.

Limited use of power generation facilities incorporating PEMs or an SME electrolyser with a PEM hydrogen fuel cell is caused mainly by the fact that the inlet of water into electrolysers needs to be pressurised requiring electrical power to drive pumps, or it is provided by swap water tanks that need to be changed or refilled. This means that the electrolyser operation requires attendance.

The drawback of power generation systems with a PEM hydrogen fuel cell powered by hydrogen gas and oxygen gas supplied from pressurized gas tanks is that this method of power generation requires these gas tanks to be changed. Again this is attended operation.

With respect to the above, it can be stated that despite the fact that all of the presented technologies implementing the electrolyte, fusion and thermoelectric processes represent the prior art, there is no solution presently known that would connect these facilities in such a combination so as to allow sufficient electric power generation, making it possible to cyclically power the electrolyser and thus create an autonomously operating electrical facility without the need for additional energy input, to the contrary generating enough energy for the electrolytic process, plus surplus energy that could be fed to the power grid or power other facilities.

The absence of such a facility created a space for research and development of such method and building of such an electric power generation facility that would create an energy-autonomous and renewable energy source having positive energy balance, capable of providing constant electric output in full operation, with no need to create backup power capacity or supply auxiliary or other energy inputs. It seems realistic to imagine that such a facility could have attendance-free operation.

This effort resulted in the combined magnetohydrodynamic and electrochemical method and facility for namely electric power generation described in the present invention below, delivering higher efficiency compared to the prior art.

### SUBJECT MATTER OF THE INVENTION

The above deficiencies of the prior art are alleviated by the combined magnetohydrodynamic and electrochemical method for namely electric power generation according to the present invention, the essence of which lies in the fact that

A. modification of the method of operating a power plant that generates electric power as its main product, with an electrolytic process of water decomposition to hydrogen and oxygen taking place in a spiral magnetic electrolyser powered by electrical pulses and fitted with permanent magnets at the water and electrolyte inlet to and outlet from the space of spirally configured electrodes. Water is fed in between the electrodes, and the active movement of electrolyte ions, electrode configuration and applied current causes a magnetic field to be generated. Water from inlet pipes is fed to an electrolytic cell, the lower (inlet) part of which is made of permanent magnets, and in the pipe it is mixed with the electrolyte. If water is in a magnetic field, each elementary atom of water molecule is also magnetized and its spin is oriented in the direction of the magnetic field. If the negative electrode is immersed in the electrolyte solution, the orientation of water atom spins in the magnetic field causes a decrease in hydrogen and oxygen dissociation levels, thereby significantly reducing the energy consumption required for water electrolysis. To create a continuous magnetic field across the flow area of the electrolyser, there are two magnets also fitted to the top of the electrolyser above the spiral electrodes. After water has dissociated, the electrolyte is channelled back to the inlet pipe where it is dissolved and (re)cycled through the process of spiral electrolysis. Owing to the structure of the spiral magnetic electrolyser the produced hydrogen and oxygen are not separated and therefore they are brought to the separator together.
So, the spiral magnetic electrolyser is submerged in an accumulator tank below the surface of the water environment and by its activity (electrolysis) it causes water from the accumulator tank environment to be decomposed, resulting in a loss of molecules and hence also of the volume of water, creating a pressure gradient in the pipe located below the surface of the surrounding water environment with its inlet located below the surrounding water environment in the accumulator tank, thus causing necessary dynamics for the water environment to move towards the spiral magnetic electrolyser.

As mentioned earlier, the secondary stage of electrochemical energy transformations in the electric power generation using this method and facility is the PEM hydrogen fuel cell comprised of a negatively charged electrode—anode, a positively charged electrode—cathode and a semi-permeable membrane with electrolyte. Supplied hydrogen oxidizes at the anode and atmospheric oxygen is reduced at the cathode. Protons are transported from the anode to the cathode through the membrane and electrons are guided to the cathode along the outer perimeter. Oxygen reacts with hydrogen protons and electrons at the cathode with water and heat being produced in the process. The anode and cathode include a catalyst to speed up the electrochemical processes. Since the PEM hydrogen fuel cell produces more heat than electric energy, this condition is utilised by including a thermoelectric module consisting of two P- and N-type semiconductors producing additional electric potential difference and being in a conductive thermoelectric contact with the heat source—PEM hydrogen fuel cell and whose free ends are thermoelectrically coupled with a cooler, the coolant of which is in thermal contact with the thermoelectric module, resulting in electric power generation based on the Seebeck effect.

Decomposition of water thus generates hydrogen and oxygen in gaseous state in form of a mixture of gases. Generated hydrogen and oxygen is channelled through a drainpipe above the water surface in the accumulator tank to the gas separator that separates gases to pure hydrogen and oxygen gas. Finally, the above electrolytic process of water decomposition and hydrogen and oxygen separation is followed by hydrogen-oxygen fusion in a hydrogen fuel cell connected directly to the gas separator, if the ultimate goal is only electric power generation, or also thermoelectrical module, in order to process waste heat from operation of the hydrogen fuel cell and increase efficiency of the overall energy balance of this facility.
B. If the aim of the combined magnetohydrodynamic and electrochemical method of electric power generation as the main product is also to transport water from the water environment in which the spiral magnetic electrolyser is applied to a horizontally and/or vertically remote system in which the hydrogen fuel cell is applied, such transport of water starts with the initial decomposition of water in liquid state to hydrogen and oxygen gas, continues with the separation and transport of at least hydrogen gas from the spiral magnetic electrolyser outlet to hydrogen fuel cell inlet and ends with hydrogen-oxygen fusion in a hydrogen fuel cell, at the outlet of which is water again in liquid or gaseous form, but in a horizontally and/or vertically or remote system. Alternatively, oxygen gas can also be transported if it is collected from the electrolyser.

The above alternatives of combined magnetohydrodynamic and electrochemical method for namely electric power generation are implemented by a combined magnetohydrodynamic and electrochemical facility for namely electric power generation consisting of at least one hydrogen fuel cell as a secondary part of the facility with the primary part of the facility being at least one spiral magnetic electrolyser, the inlet of which is submerged under the surface of a water environment. Submerged in a water environment may by the whole spiral magnetic electrolyser or at least a substantial part thereof. Connected to the outlet of the spiral magnetic electrolyser is a hydrogen separator followed by at least one hydrogen fuel cell having an outlet for water drainage and possibly also connected to a thermoelectric module.

If the combined magnetohydrodynamic and electrochemical facility is modified primarily as a power plant, then the hydrogen fuel cell water drainage outlet is looped back to the water environment without the water produced by hydrogen-oxygen fusion in the hydrogen fuel cell being utilised for any other technological or consumer purposes.

If the magnetohydrodynamic and electrochemical facility is modified primarily as a water transporter and secondarily as a power plant with additional water transport, the spiral magnetic electrolyser is completely or partially submerged under the surface of a water environment and the hydrogen fuel cell is located in a horizontally and/or vertically remote system. Such spatial distribution of the combined magnetohydrodynamic and electrochemical facility requires the spiral magnetic electrolyser to be connected to a hydrogen fuel cell, via a separator, by transport means for the transfer of hydrogen and possibly also oxygen, such as pipes, hoses, pipelines and so on. At the same time, the energy output of the hydrogen fuel cell is fed to a technological or consumer network. If only hydrogen gas is transported, the hydrogen fuel cell is fitted with air inlet, through which the hydrogen fuel cell is supplied with oxygen from the surrounding air.

A common preferred characteristic of the modifications described is the arrangement ensuring a return of electrolyte back to the pipe delivering water to the electrolyser after the electrolysis.

The output products of the hydrogen fuel cell are electric power, water and heat. To recover energy from heat as an undesirable output product of the hydrogen fuel cell (if for that specific use the generation of heat is undesirable) a thermoelectric module is integrated into the composition of the fuel cell to produce additional electric energy, which thermoelectric module works as a heat sink and thanks to the thermal gradient and heat conversion it also generates electric power.

A common characteristic of all possible uses of the combined magnetohydrodynamic and electrochemical method for namely electric power generation is that the output electric power from the hydrogen fuel cell and possibly from the thermoelectric module or a system thereof is fed back to power the spiral magnetic electrolyser or a system thereof, to the extent necessary to produce undiminished quantities of hydrogen, in order to generate constant or growing amount of electric power by the hydrogen fuel cell and possibly also by the thermoelectric module or a system thereof. If the electricity produced by this facility is not fully consumed by powering the spiral magnetic electrolyser or a system thereof, it is used as a net energy gain for subsequent consumption by feeding it to the grid or by powering specific facilities.

Advantages of the combined magnetohydrodynamic and electrochemical method and facility for namely electric power generation according to the present invention are obvious from its external effects. Effects of the present invention lie mainly in that a part of the total electric power gain from all power generating components of the system is used to run the spiral magnetic electrolysers and the remaining surplus part representing the output energy gain is used for further processing for the electric power transmission system and/or an external energy distribution system. Two described electric power generation sections thus represent, in total with the negative value of the electric power input to the spiral magnetic electrolyser system, in general, the total energy balance of the system, the value of which depends on technologies, materials and parameters used and last, but not least, also on the purpose for which the system is used. Residual thermal energy from the hydrogen-oxygen fusion unprocessed in the thermoelectric generation and/or conversion may also be utilized, if channelled by a heat duct, to heat the water environment in the accumulator tank of the spiral magnetic electrolysers, which reduces the energy required for electrolysis, which in terms of total energy balance is ultimately also an energy gain.

The control of the magnetohydrodynamic and electrochemical system lies in modifying the spiral magnetic electrolyser or a system thereof either by controlling the electrode voltage by means of a voltage and current controller or by temporarily disconnecting one or more magnetic spiral electrolysers. This will reduce the amount of hydrogen produced entering the fuel cell or a system thereof which is a means for controlling the output power and stability of the system.

An undoubtful benefit of the combined magnetohydrodynamic and electrochemical method and device for namely electric power generation of the present invention is its maximum ecological value in relation to possible energy gains, as well as the fact that the majority of emissions from this system are oxygen and water, with it being a renewable energy source capable of delivering constant power with no need to create backup power capacity. From the economic and logistic point of view it is an utmost effective solution considering its installation and maintenance requirements, since there is a minimum number, even absence, of mechanical components, which solution requires in particular the sufficient volume of water for processing, with the said volume of water being returned after use back to the environment as an output product. As a result of the above, the system can be installed, without the need for costly and time consuming work, to any water environment, be it inland bodies of water and streams, or seas and oceans. Given the fact that it is a progressive, safe, environmentally friendly and economical solution for even sea water processing, this system represents, in terms of utilisation of the potential of seas and oceans as well as inland water bodies and streams, in terms of industrial applicability, but also in terms of global ecological, economic and social prospects, a technological benefit of priceless value.

In terms of usability of the combined magnetohydrodynamic and electrochemical method and facility for namely electric power generation there are also other possibilities of alternative uses for other than the primary electric power generation option coming into consideration, such as a facility for conveying water to higher and/or remote areas without the need to use conventional pumping technologies or water pumping and/or transportation means, and/or reduction of water levels in specific locations and the transport of water to target locations. Another possibility that can be considered is to use it as the utmost economic and ecological propulsion for ships and/or other water machines and/or transport means, depending on the design possibilities and energy outputs required, where for instance in the case of ships it is theoretically possible to consider using these hydrodynamic sections for direct generation of the momentum of such a structures relative to the surrounding environment.

### BRIEF DESCRIPTION OF THE DRAWINGS

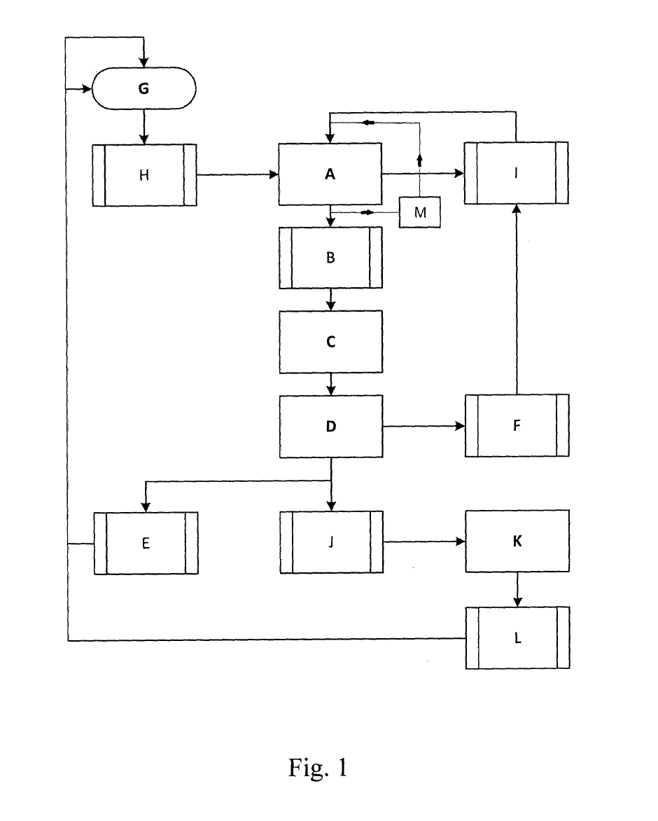

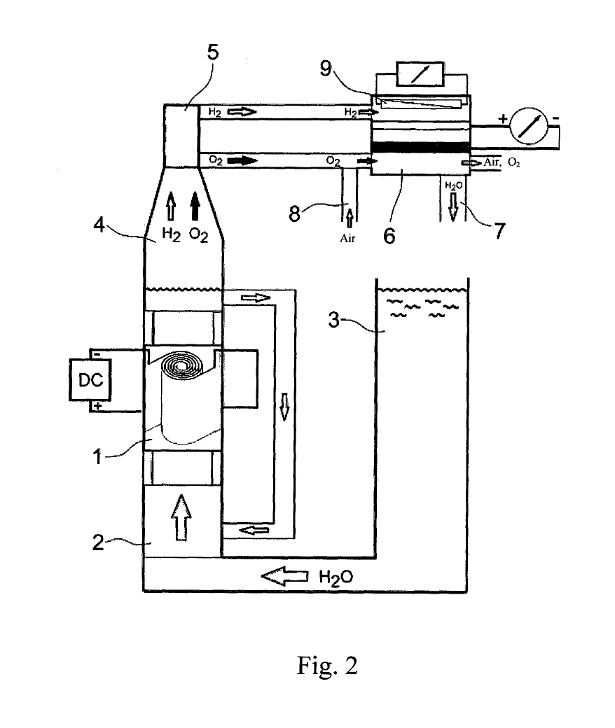

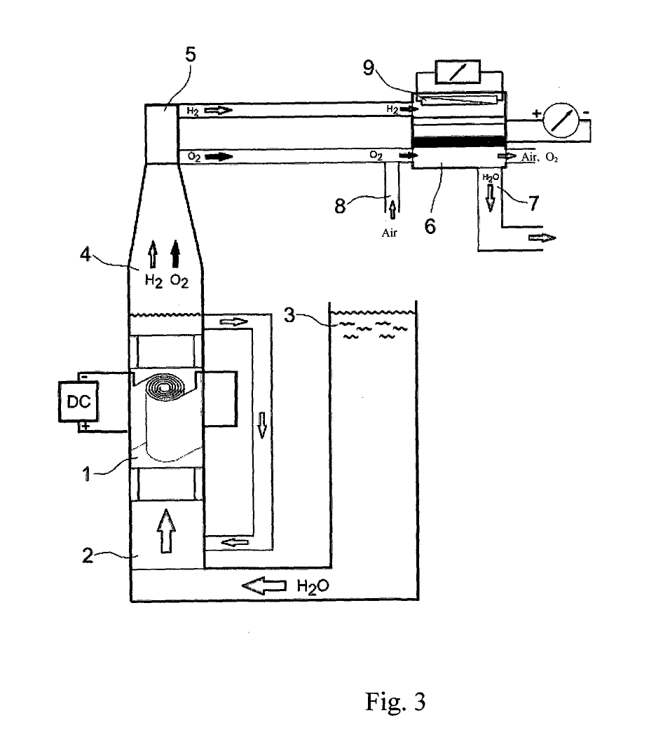

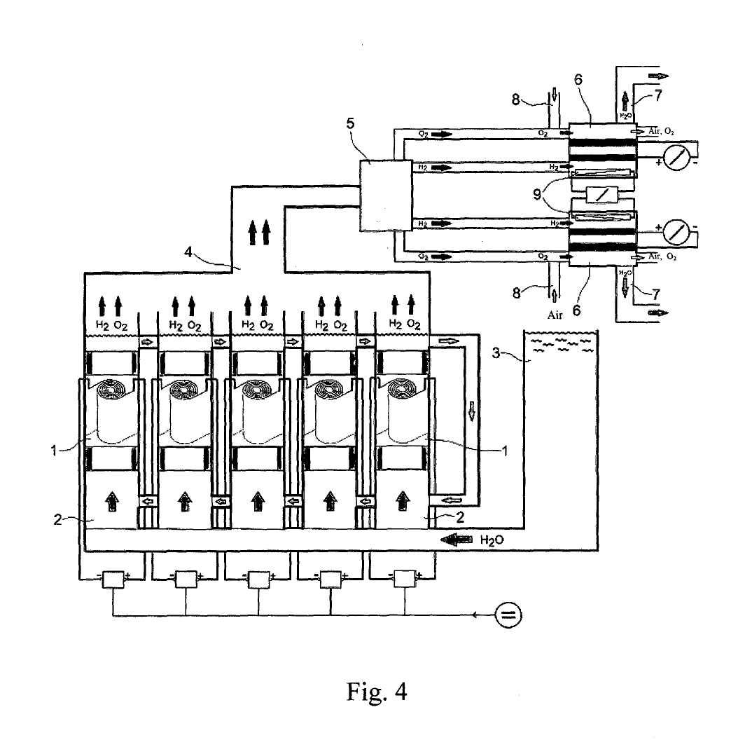

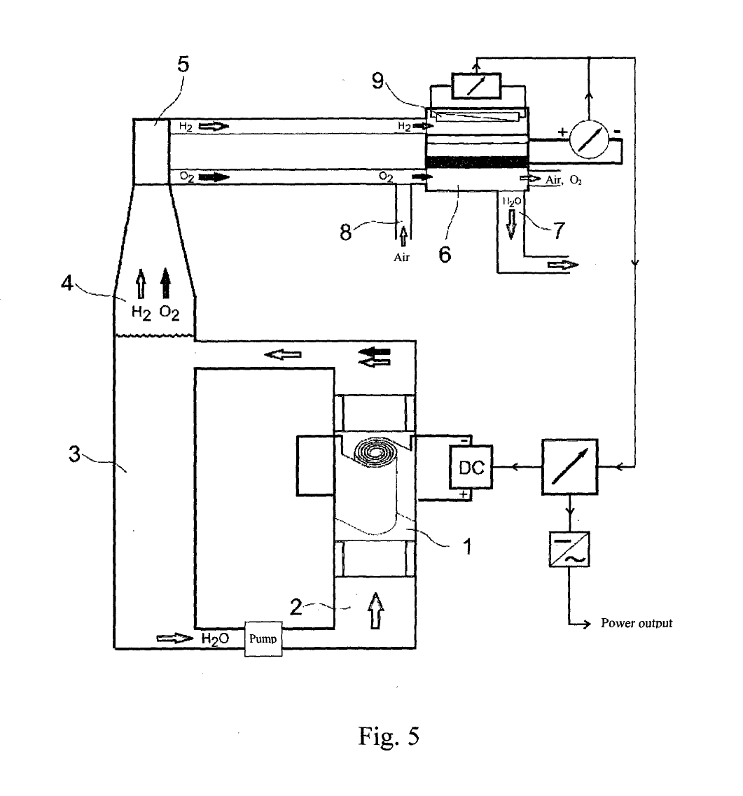

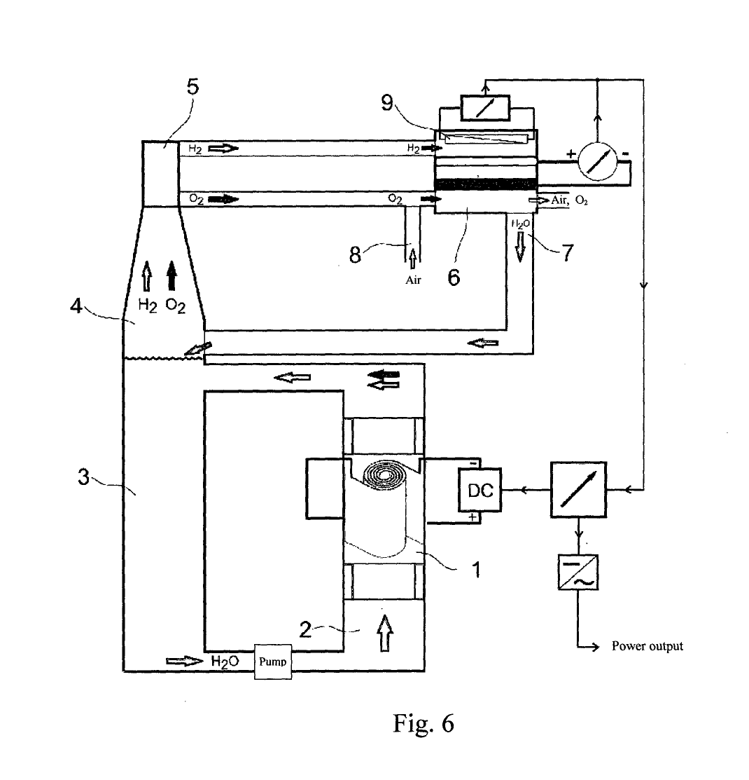

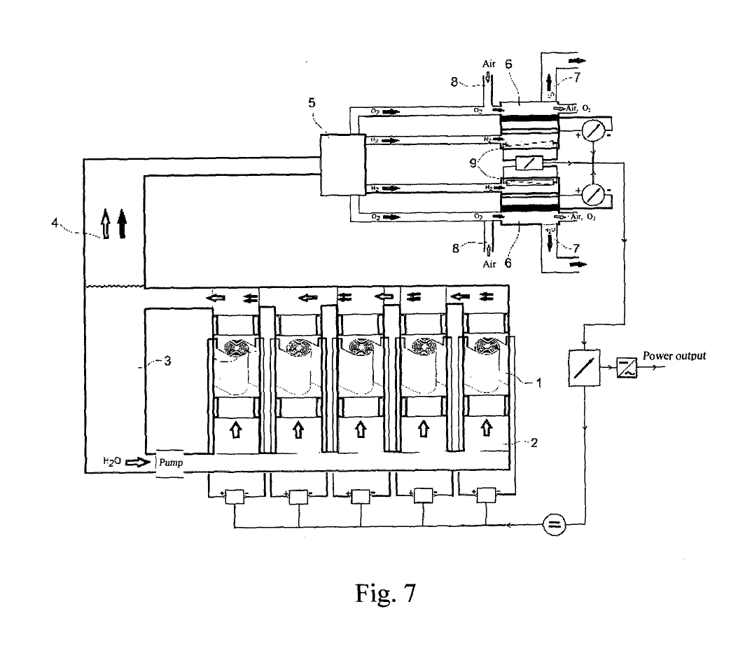

Combined magnetohydrodynamic and electrochemical method and facility for namely electric power generation according to the present invention will be explained in more detail by means of exemplary embodiments shown in the drawings, where FIG. 1 shows a block diagram of individual technological process steps of the method outlining possible embodiment options. FIG. 2 shows a combined magnetohydrodynamic and electrochemical facility for electric power generation in the power plant arrangement. FIG. 3 shows a combined magnetohydrodynamic and electrochemical facility for electric power generation in the power plant and water transport facility arrangement. FIG. 4 shows a control of multiple combined magnetohydrodynamic and electrochemical facilities for electric power generation in the power plant and water transport facility arrangement.

### DESCRIPTION OF THE PREFERRED EMBODIMENTS

It is understood that the individual embodiments of the combined magnetohydrodynamic and electrochemical method and facility for namely electric power generation according to the present invention are shown by way of illustration only and not as limitations. Those skilled in the art will recognize, or be able to ascertain using no more than routine experimentation, many equivalents to the specific embodiments of the invention. Such equivalents are intended to be encompassed by the following claims.

Those skilled in the art would have no problem dimensioning the combined magnetohydrodynamic and electrochemical method and facility for namely electric power generation and choosing suitable materials and design configurations, which is why these features were not designed in detail.

### Example 1

This example of a specific embodiment of the present invention describes a basic combined magnetohydrodynamic and electrochemical method of generating electric power as the main product and producing water as a by-product using an electrolytic process of decomposing water to hydrogen and oxygen in a spiral magnetic electrolyser 1 under the surface of a water environment 3. Necessary dynamization of the water environment in the water supply system 3 to the spiral magnetic electrolyser 1 is induced by negative pressure resulting from water being decomposed on electrodes of the magnetic spiral electrolyser 1. The electrolytic process of water decomposition is followed by hydrogen and oxygen separation in a gas separator 5 and hydrogen-oxygen fusion in a hydrogen fuel cell 6 connected immediately after a separator 5. The basic combined magnetohydrodynamic and electrochemical method of electric power generation can be characterised by a general block diagram shown in FIG. 1 with the following sequence of steps: A-C-D-F-G-H and M.

### Key to the Process Steps:

A—SME electrolyser, water electrolysis, hydrogen and oxygen production
B—Hydrogen and oxygen production and their transport to higher elevations
C—Gas separator, hydrogen and oxygen separation
D—PEM hydrogen fuel cell, electric power generation based on hydrogen-oxygen fusion
E—Production of output electrical power by the PEM hydrogen fuel cell
F—Production of water as the output product of PEM hydrogen fuel cell and its outlet to a lower situated target point
G—The target energy balance of the magnetohydrodynamic and electrochemical system
H—Consumption of the input electric power required for electrolysis and taken from the target energy balance of the magnetohydrodynamic and electrochemical system
E—Output electric power for further PEM hydrogen fuel cell processing
E—Output heat produced by the PEM hydrogen fuel cell
K—Thermoelectric module, energy produced from part of the heat generated by the PEM hydrogen fuel cell
L—Output electrical power produced by the thermoelectric module
M—A return of electrolyte back to the pipe delivering water to the electrolyser after the electrolysis.

Another alternative embodiment of the combined magnetohydrodynamic and electrochemical method of electric power generation includes the following sequence of technological steps: J-K-L incorporated in between D-G.

### Example 2

This example of a specific embodiment of the invention describes a derived combined magnetohydrodynamic and electrochemical method of generating electric power as the main product and transporting water from the water environment using an applied spiral magnetic electrolyser 1 to a horizontally and/or vertically remote system including an applied hydrogen fuel cell 6. The electric power generation is sufficiently described in Example 1. In addition, the transport of water starts with the initial decomposition of water in liquid state to hydrogen and oxygen gas, continues with the transport of at least hydrogen gas from the spiral magnetic electrolyser 1 outlet to the hydrogen fuel cell 6 inlet through the separator 5 and ends with hydrogen-oxygen fusion in the hydrogen fuel cell 6, at the outlet of which water is in liquid or gaseous form again, but in the horizontally and/or vertically remote system. Alternatively, oxygen gas can also be transported if it is collected from the electrolyser 1. The derived combined magnetohydrodynamic and electrochemical method of electric power generation and water transport can be characterised by the general block diagram shown in FIG. 1 with the following sequence of steps: A-C-D-(E-F)-G-H-I and M.

Lastly, in an alternative embodiment of the combined magnetohydrodynamic and electrochemical method of electric power generation and/or water transport there is a sequence of all technological steps: A to M in the above sequences.

### Example 3

This example of a specific embodiment of the invention describes the basic combined magnetohydrodynamic and electrochemical facility for electric power generation modified for power plant use as shown in FIG. 2. It comprises a spiral magnetic electrolyser 1 connected to which, through the separator 5, is the hydrogen fuel cell 6 located in one and the same place. The spiral magnetic electrolyser 1 has its inlet 2 submerged under the surface of a water environment 3. The outlet 4 of the spiral magnetic electrolyser 1 is connected through the separator 5 to the hydrogen fuel cell 6 having its outlet 7 in the water environment 3.

In an alternative embodiment of the combined magnetohydrodynamic and electrochemical facility for electric power generation the hydrogen fuel cell 6 is fitted with a thermoelectric stage 9.

### Example 4

This example of a specific embodiment of the invention describes a derived combined magnetohydrodynamic and electrochemical facility for electric power generation modified for power plant and water transport use as shown in FIG. 3. It comprises a spiral magnetic electrolyser 1 connected to which, through a separator 5 by a gas connection, is a hydrogen fuel cell 6. The spiral magnetic electrolyser 1 has its inlet 2 submerged under the surface of a water environment 3. The hydrogen fuel cell 6 is situated in a horizontally and vertically remote system. The energy output of the hydrogen fuel cell 6 is fed to another technological or consumer network.

In an alternative embodiment of the combined magnetohydrodynamic and electrochemical facility for electric power generation and water transport the hydrogen fuel cell 6 is fitted with an air inlet 8.

In an alternative embodiment of the combined magnetohydrodynamic and electrochemical facility for electric power generation and water transport there are several parallel spiral magnetic electrolysers 1 and several parallel hydrogen fuel cells 6 as shown in FIG. 4.

### INDUSTRIAL APPLICABILITY

The combined magnetohydrodynamic and electrochemical method and facility for namely electric power generation according to the present invention can be applied in the energy and water management industries.

1. A combined magnetohydrodynamic and electrochemical method and facility for namely electric power generation through a hydrogen-oxygen fusion in a hydrogen fuel cell, wherein electric power as the main product is generated by using an electrolytic process of decomposing water to hydrogen and oxygen in a spiral magnetic electrolyser under the surface of a water environment where the dynamization of the water environment in the water supply system at the inlet of a spiral magnetic electrolyser is induced by negative pressure resulting from water being decomposed at the outlet of the spiral magnetic electrolyser, with the electrolytic water decomposition process being followed by separation of hydrogen and oxygen in a gas separator and subsequent hydrogen-oxygen fusion in a hydrogen fuel cell, the energy output of which is in whole or in part used to power the spiral magnetic electrolyser.

2. A combined magnetohydrodynamic and electrochemical method of namely electric power generation as defined in claim 1, wherein the generation of electric power as the main product also includes transport of water from the water environment in which the spiral magnetic electrolyser is applied, to a horizontally and/or vertically remote system in which the hydrogen fuel cell is applied, with such transport of water starting with the initial decomposition of water in liquid state to hydrogen and oxygen gas, continuing with the separation in the gas separator and transport of at least hydrogen gas from the spiral magnetic electrolyser outlet to the hydrogen fuel cell inlet and ending with hydrogen-oxygen fusion in the hydrogen fuel cell, at the outlet of which water is again in liquid or gaseous form, with the energy produced by the hydrogen-oxygen fusion being in whole or in part used to power the spiral magnetic electrolyser.

3. A combined magnetohydrodynamic and electrochemical facility for namely electric power generation comprising a hydrogen fuel cell wherein at least one spiral magnetic electrolyser has its inlet submerged under the surface of a water environment, with the outlet of the spiral magnetic electrolyser being connected through a gas separator to at least one hydrogen fuel cell with a water outlet, the electrical power output of which is in whole or in part used to power the spiral magnetic electrolyser.

4. A combined magnetohydrodynamic and electrochemical facility for namely electric power generation as defined in claim 3, wherein in the power plant arrangement the water outlet of the hydrogen fuel cell is fed back to the water environment.

5. A combined magnetohydrodynamic and electrochemical facility for namely electric power generation as defined in claim 3, wherein in the power plant and water transport arrangement the spiral magnetic electrolyser is applied under the surface of the water environment and the hydrogen fuel cell, connected through the separator, is situated in a horizontally and/or vertically remote system, with the energy output of the hydrogen fuel cell to the extent not used for powering the spiral magnetic electrolyser being supplied to another technological or consumer network.

6. A combined magnetohydrodynamic and electrochemical facility for namely electric power generation as defined in claim 3, wherein the hydrogen fuel cell is fitted with an air supply inlet.

7. A combined magnetohydrodynamic and electrochemical facility for namely electric power generation as defined in claim 3, wherein the hydrogen fuel cell is fitted with a thermoelectrical stage, the energy output of which is supplied together with the output from the hydrogen fuel cell, to the extent not used for powering the spiral magnetic electrolyser, to another technological or consumer network.
